(19) United States
(12) Patent Application Publication
(10) Pub. No.: US 2010/0092017 A1
(43) Pub. Date: Apr. 15, 2010

(54) HEARING SYSTEM AND METHOD FOR OPERATING THE SAME

(75) Inventor: Bernd Waldmann, Maur (CH)

Correspondence Address: PEARNE & GORDON LLP, 1801 EAST 9TH STREET, SUITE 1200, CLEVELAND, OH, 44114-3108, US

(73) Assignee: PHONAK AG, Staefa (CH)

(21) Appl. No.: 12/596,046

(22) PCT Filed: Apr. 18, 2007
(86) PCT No.: PCT/EP07/53752

§ 371 Date: Oct. 15, 2009

(51) Int. Cl. H04R 25/00

(52) U.S. Cl. 381/315

(57) ABSTRACT

The hearing system (2) comprises a storage unit (11), which comprises location-related data, which are data related to the hearing system's current location. This way, it is possible to provide that the function of the hearing system (2) changes in dependence of the location the hearing system is in. In one embodiment, said location-related data comprise at least one location class identifier, wherein a location class identifier indicates, to which of a multitude of location classes said current location of said hearing system belongs. According to the invention, the method for operating a hearing system (2) comprises the step of obtaining location-related data, which are data related to the hearing system's current location.

### TECHNICAL FIELD

The invention relates to the field of hearing devices and hearing systems. It relates to methods and apparatuses according to the opening clause of the claims.

Under a hearing device, a device is understood, which is worn in or adjacent to an individual's ear with the object to improve the individual's acoustical perception. Such improvement may also be barring acoustic signals from being perceived in the sense of hearing protection for the individual. If the hearing device is tailored so as to improve the perception of a hearing impaired individual towards hearing perception of a “standard” individual, then we speak of a hearing-aid device. With respect to the application area, a hearing device may be applied behind the ear, in the ear, completely in the ear canal or may be implanted.

A hearing system comprises at least one hearing device, e.g., a hearing-aid device. Typically, a hearing system comprises, in addition, at least one additional device, which is operationally connected to said hearing device, e.g., another hearing device, a remote control, a remote microphone or a mobile communication device. Such an additional device usually is a mobile device and typically a device belonging to said user.

### BACKGROUND OF THE INVENTION

Hearing devices and hearing systems are well known in the art. Some modern hearing systems have wireless communication capabilitites. E.g., from EP 1 628 503 A2, a hearing device is known, which is adapted to automatically requesting an establishment of a communication connection to a support provider upon an automatic detection of a failure of the hearing device.

Inspired by today's hearing devices' communication capabilitites, the invention suggests to provide hearing systems with new or enhanced functionalities.

### SUMMARY OF THE INVENTION

One object of the invention is to create a hearing system and a system comprising a hearing system and a method for operating a hearing system, which provide for new functionalities.

Another object of the invention is to improve the quality of life of hearing system users.

Another object of the invention is to provide hearing system users with an improved hearing experience.

Further objects emerge from the description and embodiments below.

At least one of these objects is at least partially achieved by apparatuses and methods according to the patent claims.

The hearing system comprises a storage unit, which comprises location-related data, which are data related to the hearing system's current location.

This way, it is possible to provide that the function of the hearing system changes in dependence of the location the hearing system is in.

In particular, location-related data can be data describing and/or characterizing a location, in particular said current location.

In one embodiment, said location-related data comprise data related to the geographical location of the hearing system.

The geographical location may e.g., be expressed in global geographical coordinates like degree of longitude and degree of latitude, or as country, city, street name and house number.

In one embodiment, said location-related data comprise data related to the relative location of said hearing system with respect to another object. Said other object can be an immobile object. It is also possible to consider mobile objects as said other object.

Examples for immobile objects are locations (such as houses), at which certain types of services or products are available, such as branch offices of service providers or product vendors.

Examples for mobile objects are means of transportation or vehicles, such as trains or cars.

In one embodiment, said location-related data comprise at least one location class identifier, wherein a location class identifier indicates, to which of a multitude of (typically pre-defined) location classes said current location of said hearing system belongs.

Locations belonging to one location class share at least one property characterizing that class. E.g., at the location, the hearing system user can be provided with information, or with a certain type of information; or specific services are available at or near the location; or specific products are available at or near the location; or the location provides touristic sites; or the location has specific acoustic properties.

In one embodiment, the hearing system comprises a storage unit, which comprises at least one instruction for each of at least a portion of said multitude of location classes.

This allows to adjust the hearing system's behaviour in dependence of its current location in a very efficient manner. E.g., said storage unit could comprise a lookup-table having entries such as “play audio stream number 3 to the user” for one location class; or “do not play to the user the audio stream available at this site” for another location class; or “change to hearing program number 4” for another location class; or “download audio processing parameters available at this site and use them” for another location class.

Preferably, said instructions are pre-defined instructions. Said at least one instruction may comprises at least one of
an instruction to play an audio stream and/or a visual message to the user of said hearing system;
an instruction not to play an audio stream and/or a visual message to the user of said hearing system;
an instruction to carry out an adjustment of at least one audio processing parameter of a signal processor of said hearing system.

Said audio stream can represent, e.g., a message, preferably in spoken form, or a jingle, or acoustic icons, in particular sounds that are intuitively connected to a certain product or service, e.g., products or services being advertised, e.g., sounds associated with certain kinds of foods or drinks such as the sound of pouring beer into a glass.

In one embodiment, said audio stream and/or a visual message and/or said adjustment is received by said hearing system in said current location of said hearing system. This allows to minimize storage space within the hearing system required for storing said audio stream and/or said adjustment.

In one embodiment, said audio stream and/or a visual message and/or said adjustment is pre-stored in said hearing system. This can reduce the amount of data to be transmitted to the hearing system.

In one embodiment, the hearing system comprises a communication unit comprising at least one of a receiver, a transmitter, a transceiver, for wirelessly communicating with a communication unit external to said hearing system.

In one embodiment, the hearing system comprises an extraction unit for obtaining said location-related data from location-related signals, which are signals carrying information related to the hearing system's current location. Such information-carrying signals may be signals transmitted for instance as electromagnetic waves or as sound waves, in particular ultrasound waves. For example, encoded in carrier waves, e.g., by modulation of carrier waves, the information can be transferred to the hearing system.

Through this, the hearing system can be provided with information related to the hearing system's current location wherever such location-related signals are available.

A system according to the invention comprises a hearing system according to the invention and the above-mentioned communication unit and the above-mentioned external communication unit.

In one embodiment of the system according to the invention, the hearing system comprises the above-mentioned extraction unit, and said location-related signals are signals transmitted from said external communication unit to said hearing system.

According to the invention, the method for operating a hearing system comprises the step of
a) obtaining location-related data, which are data related to the hearing system's current location.

In one embodiment of the method, said location-related data comprise at least one location class identifier.

In one embodiment, the method comprises the step of
selecting, in dependence of said at least one location class identifier, at least one instruction.

A hearing system can comprise a selecting unit for accomplishing this.

Preferably, said at least one instruction is selected from a multitude of instructions.

Preferably, the method, in addition, comprises the step of
carrying out said selected at least one instruction.

In one embodiment, said instructions are pre-defined instructions.

It is possible to take (or even leave out) an action, in dependence of said at least one location class identifier.

In one embodiment, said carrying out said at least one instruction comprises at least one of the steps of
playing an audio stream and/or a visual message to the user of said hearing system;
not playing an audio stream and/or a visual message to the user of said hearing system;
carrying out an adjustment of at least one audio processing parameter of a signal processor of said hearing system.

In one embodiment, the method comprises the step of
establishing a wireless communication connection between said hearing system and a communication unit external to said hearing system.

In one embodiment, said obtaining location-related data comprises the step of
obtaining said location-related data from location-related signals, which are signals carrying information related to the hearing system's current location.

The advantages of the methods correspond to the advantages of corresponding apparatuses and vice versa.

Further preferred embodiments and advantages emerge from the dependent claims and the figures.

### BRIEF DESCRIPTION OF THE DRAWINGS

Below, the invention is described in more detail by means of examples and the included drawings. The figures show:

FIG. 1 a block diagram illustrating a system and a hearing system according to the invention;

FIG. 2 a schematic illustration of an embodiment of the invention;

FIG. 3 a schematic illustration of an embodiment of the invention.

The reference symbols used in the figures and their meanings are summarized in the list of reference symbols. The described embodiments are meant as examples and shall not confine the invention.

### DETAILED DESCRIPTION OF THE INVENTION

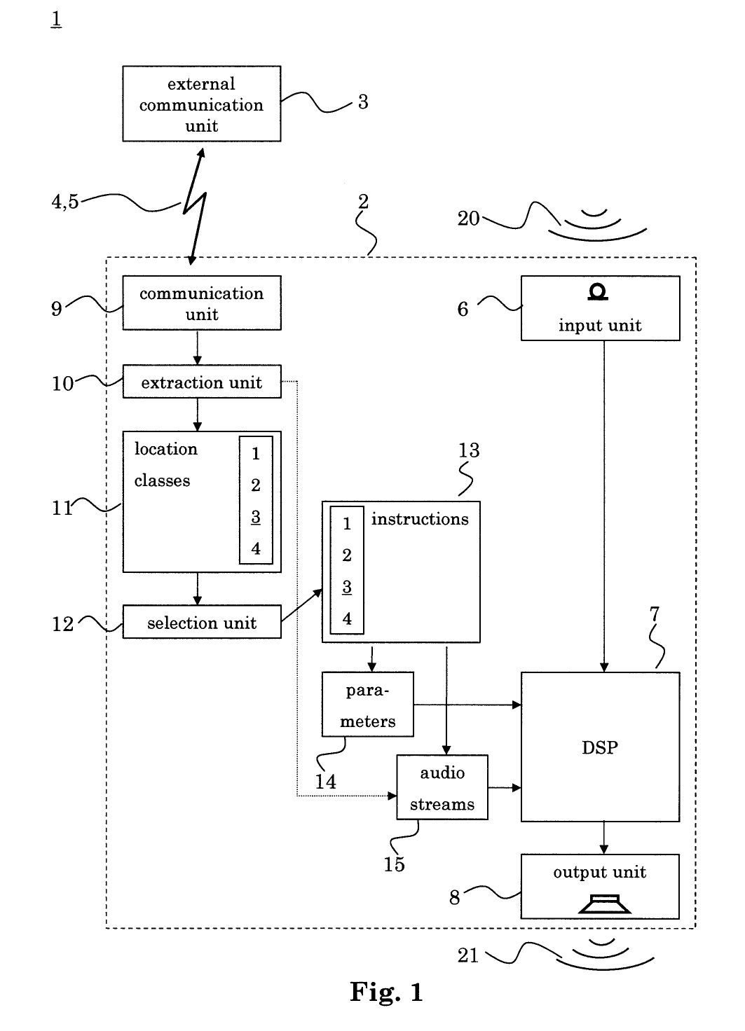

FIG. 1 shows a block diagram illustrating a system 1 according to the invention and a hearing system 2 according to the invention. System 1 comprises hearing system 2 and an external communication unit 3, which are operationally connected to each other.

Hearing system 2 comprises an input unit 6, a signal processing unit 7 and an output unit 8. Hearing system 2 furthermore comprises a communication unit 9, an extraction unit 10, a storage unit 11, a selection unit 12, a storage unit 13, a storage unit 14 and a storage unit 15.

The various constituents of hearing system 2 may be comprised in one device of hearing system 2 or may be distributed among—if applicable—two or devices of hearing system 2.

During standard operation, hearing system 2 receives acoustic waves 20, which are converted by means of input unit 6 into analog and/or digital audio signals, which are processed in signal processing unit 7 and finally fed to output unit 8, so as to obtain signals 21 to be perceived by the user, typically acoustic waves.

The external communication unit 3 is typically related to a location, e.g., to a specific room, office, shop, touristic sight. In this case, a communication connection 4 that can be established between the external communication unit 3 and the hearing system 2 (more precisely: the communication unit 9) is typically a short-range communication connection 4, e.g., using the well-known Bluetooth standard. For example, such a short-range communication connection 4 can be established as soon as the hearing system 2 is located within the available communication range, typically between 1 m and 50 m. It is also possible to start the establishment of said communication connection 4 upon detecting that external communication unit 3 and hearing system 2 are close within a certain distance, e.g., using an RFID (Radio Frequency IDentification) technique, e.g., with a passive (no-power-consuming) RFID chip integrated in the hearing system and a corresponding sensor at the location.

The external communication unit 3 can be arranged at the location it is associated with, or in a position in a well-defined relation to said location. In the latter case, the external communication unit 3 can be used for guiding a hearing system user distant from said location towards said location.

Usually, said communication connection 4 is a wireless communication connection.

The communication connection 4 between external communication unit 3 and the hearing system 2 can be one way (from external communication unit 3 to communication unit 9, or from communication unit 9 to external communication unit 3), or it may be a two-way communication connection 4, as indicated in FIG. 1.

The external communication unit 3 cannot only be associated with immobile objects, but can also be associated with a mobile object, such as a train or bus.

Alternatively, external communication unit 3 can be associated with a location information provider, e.g., a location information provider for geographical positions, such as the well-known GPS (Global Positioning System). In this case, the hearing system 2 can, e.g., automatically or upon request, receive data from the external communication unit 3.

Via the communication connection 4, the hearing system 2 receives location-related signals 5, which carry information related to the hearing system's current location, also referred to as location-related information. For purposes of the invention, the current location of the hearing system 2 is typically reflected in the current location of one device of the hearing system 2 or to the current location of the hearing system user. Making use of a possible sub-meter resolution of information related to the hearing system's current location is typically not envisaged in the invention.

It is to be noted that said location-related signals 5 carry said information related to the hearing system's current location. Hearing system 2 has said extraction unit 10 for extracting said information from said location-related signals 5. This has to be distinguished from systems, in which a signal that does not carry such location-related information is analyzed, e.g., with respect to its intensity, and where, when a certain threshold intensity is exceeded, a certain action is taken, e.g., it is switched from a microphone as input converter to a telephone coil as input converter.

Said location-related signals 5 can be based, e.g., on electromagnetic waves (typically radio waves, but possibly also optical waves, e.g., in the infrared or in the visible region), or on ultrasound.

Data representative of said information related to the hearing system's current location are, after extraction of the information from the location-related signals 5, stored in storage unit 11.

Said information related to the hearing system's current location can indicate, e.g., the geographical position of the hearing system 2, or the nearness of a place with specific properties, e.g., a place at which certain services and/or products are provided. In particular, said information related to the hearing system's current location can comprise a location class identifier, i.e., data which indicate that said location is a location belonging to a certain class of locations.

For example, as shown in FIG. 1, storage unit 13 comprises instructions for the case of different location classes, and selection unit 12 selects, in dependence of the (current) location class stored in storage unit 11, that one set of instructions comprising one or more instructions, which are to be carried out in case that the current location is of this class.

Two important examples of instructions are indicated in FIG. 1: Certain parameters of the hearing system 2, in particular audio processing parameters, stored in storage unit 14, can be adjusted in dependence of the current location, and/or one or more audio streams, stored in storage unit 15 in form of data representing audio signals, can be played to the user of the hearing system 2. The audio stream data can be pre-stored in hearing system 2 and/or can be extracted from signals received by means of communication unit 9 (e.g., as indicated by the dotted arrow in FIG. 1, by extraction unit 10).

In another example, visual, in particular audio-visual messages are presented in dependence of the current location. E.g., a display of a remote control of the hearing system can be used for displaying information such as text. Data representing such information can be pre-stored in the hearing system and/or can be loaded into the hearing system, analogously to the above-described data representing audio signals.

In any event, the operation of the hearing system 2 and, more particularly, its operation, can be influenced by the location it is in.

Examples for more concrete applications are given below.

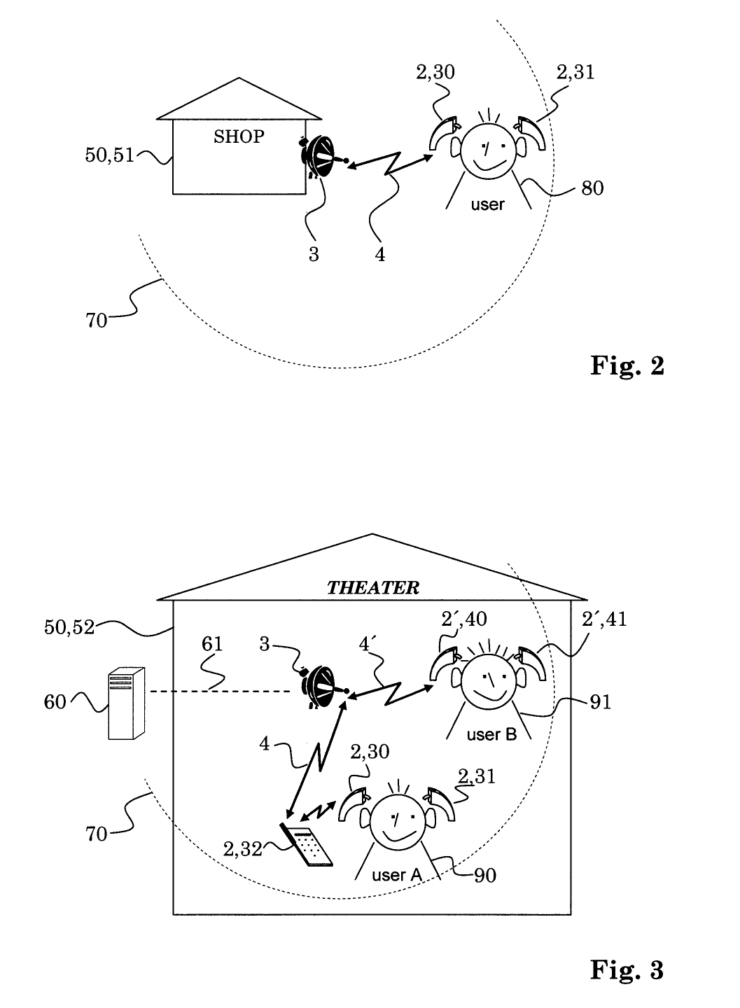

FIG. 2 shows a schematic illustration of an embodiment of the invention. As to the details of the hearing system, it can be referred to the embodiment depicted in FIG. 1. A location 50, e.g., a shop or branch 51 is provided with a communication unit 3 (external communication unit 3). A user 80 wearing a hearing system 2 comprising two hearing devices 31,32 is located close to the location 50, more particularly so close that a communication connection 4 can be established between external communication unit 3 and hearing system 2. The communication range is labelled 70. For example, it is possible that user 80 is provided, via said communication connection 4, with an audio stream which advertises products and/or services offered at the shop 51. Possibly, a location class indicator is transmitted to the hearing system 2, which indicates, e.g., that the current location the user 80 and his hearing system 2 are in, is a location of that one class of locations, which offer audio streams to hearing system users. It may be pre-programmed (e.g., by user 80) that in such locations, such audio streams shall not be played to user 80, maybe not even be loaded into hearing system 2. Or, the location 50 may be of that one class of locations, which belong to a certain group of locations providing audio streams, e.g., branches of the hearing system seller of which user 80 is a client. And for this location class, it may be preselected that the loadable audio streams will be played to the user. It is even possible to provide that users 80, which do not block receiving certain information (such as audio streams) from certain locations, receive a gratification such as a discount for their hearing system 2 or for accessories or services therefor. As mentioned before, instead of or in addition to audio streams, video streams or other visual messages can be used analoguously.

FIG. 3 shows a schematic illustration of another embodiment of the invention. In this embodiment, the location 50 is, e.g., a location having peculiar acoustic properties, e.g., a church, a theater, or a concert hall 52. A first user 91 having a hearing system 2 comprising two hearing devices 30,31 and a remote control 32, has received information via communication connection 4, that at that location, it is possible to leave messages for further hearing system users, i.e. that this location 52 belongs to the class of locations at which hearing system users can leave information for other hearing system users. User 90 transmits information to external communication unit 3, which is stored in a storage means, e.g., in a computer or server 60, which can be located at location 52 or remote.

This information may comprise comments of user 90 about performances or works offered at location 52, and/or this information may concern the acoustic properties of the location 52. In the latter case, user 90 may transmit audio processing parameters and/or hearing programs, which proved particularly suited in location 52 (preferably along with information describing his hearing system 2).

When later, a second user 91 with a hearing system 2′, e.g., comprising two hearing devices 40,41, comes into the communication range 70, he might be offered to receive such information, e.g., by receiving a corresponding location class indicator via communication connection 4′. User 91 can decide whether or not to make use of offered information, e.g., whether or not to adjust audio processing parameters according to the offered information.

In another embodiment, which can be explained using FIG. 3, information concerning the acoustic properties of location 52 may be provided at location 52, even if not provided by a former hearing system user. Corresponding data can be pre-determined and provided at location 52, possibly even different versions for different makes or models of hearing systems.

An optical communication connection 4/4′ could be embodied in the following way: At or near the location, e.g., at a wall, a 2D-bar code is provided, an image of which is taken and loaded into the hearing system, e.g., using a photographic apparatus such as a camera built-in in a mobile device such as a mobile phone or PDA (personal digital assistant) operationally connected to the hearing system. The image is evaluated, and the information such as audio processing parameters are extracted to be used in the hearing system.

It is pointed out, that this way of deriving parameters in a specific location is clearly distinct from the so-called classification well-known in the field of hearing-aid devices. In such a classification, the acoustic waves present at the location and meant to be processed and then presented to the hearing system user (confer FIG. 1, reference symbols 20, 6, 7, 8, 21), are analyzed, and audio processing parameters obtained from this analysis are then used in the hearing system, so as to hopefully achieve an improved hearing sensation for the user. In the above-described embodiment of the invention, information about audio processing parameters is not obtained from signals (such as acoustic waves) present at the location and meant to be processed and then presented to the hearing system user. Such information is obtained from other signals received in the hearing system.

The linear dimension of a location of interest in conjunction with the invention can be, e.g., of the order of 1 km, such as a city, of the order of 100 m, such as a big building, of the order of 10 m, such as a room, or of the order of 1 m, such as a position in a room. Usually, said linear dimension does not exceed 5 km; and usually said linear dimension is not below 50 cm (which approximately is of the order of the linear dimension of the space over which the hearing system is distributed).

In another embodiment, not illustrated in a figure, the hearing system receives location information, e.g., via GPS or by localizing using a location of a mobile communication device operationally connected to the hearing system, and, depending on this location information, audio streams pre-stored in the hearing system are played to the user. This can be advantageous, e.g., when the hearing system user is on a sightseeing tour, and he wants the sights explained by the hearing system when at the corresponding location.

### LIST OF REFERENCE SYMBOLS

1 system
2,2′ hearing system
3 communication unit, external communication unit, transceiver
4,4′ communication connection
5 location-related signals
6 input unit, acoustic-to-electric converter arrangement, microphone arrangement, microphone
7 signal processing unit, signal processor, digital signal processor
8 output unit, electric-to-acoustic converter arrangement, loudspeaker
9 communication unit, transceiver, receiver
10 extraction unit
11 storage unit
12 selection unit
13 storage unit
14 storage unit, parameter storage, audio processing parameter storage
15 storage unit, audio stream storage
16 audio signals, audio stream
20 acoustic waves
21 signals to be perceived by the user
30 hearing device
31 hearing device
32 remote control
40 hearing device
41 hearing device
50 location
51 shop, branch
52 theater, museum, concert hall, church
60 computer, server
61 operational connection
70 communication range
80 user
90 user
91 user

What is claimed is:

1. Hearing system comprising a storage unit, which comprises location-related data, which are data related to the hearing system's current location.

2. The hearing system according to claim 1, wherein said location-related data comprise data related to the geographical location of the hearing system.

3. The hearing system according to claim 1, wherein said location-related data comprise data related to the relative location of said hearing system with respect to another object.

4. The hearing system according to claim 3, wherein said other object is an immobile object.

5. The hearing system according to claim 1, wherein said location-related data comprise at least one location class identifier, wherein a location class identifier indicates, to which of a multitude of location classes said current location of said hearing system belongs.

6. The hearing system according to claim 5, which comprises a storage unit, which comprises at least one instruction for each of at least a portion of said multitude of location classes.

7. The hearing system according to claim 6, wherein said at least one instruction comprises at least one of
an instruction to play an audio stream and/or a visual message to a user of said hearing system;
an instruction not to play an audio stream and/or a visual message to the user of said hearing system;
an instruction to carry out an adjustment of at least one audio processing parameter of a signal processor of said hearing system.

8. The hearing system according to claim 7, wherein said audio stream and/or a visual message and/or said adjustment is stored in said hearing system.

9. The hearing system according to claim 7, wherein said audio stream and/or a visual message and/or said adjustment is received by said hearing system in said current location of said hearing system.

10. The hearing system according to claim 1, which comprises a communication unit comprising at least one of a receiver, a transmitter, a transceiver, for wirelessly communicating with a communication unit external to said hearing system.

11. The hearing system according to claim 1, comprising an extraction unit for obtaining said location-related data from location-related signals, which are signals carrying information related to the hearing system's current location.

12. A system comprising a hearing system according to claim 10 and said external communication unit mentioned in claim 10.

13. The system according to claim 11, wherein said hearing system is a hearing system according to claim 11, and wherein said location-related signals are signals transmitted from said external communication unit to said hearing system.

14. Method for operating a hearing system, comprising the step of
a) obtaining location-related data, which are data related to the hearing system's current location.

15. The method according to claim 14, wherein said location-related data comprise data related to the geographical location of the hearing system.

16. The method according to claim 14, wherein said location-related data comprise data related to the relative location of said hearing system with respect to another object.

17. The method according to claim 16, wherein said other object is an immobile object.

18. The method according to claim 14, wherein said location-related data comprise at least one location class identifier, wherein a location class identifier indicates, to which of a multitude of location classes said current location of said hearing system belongs.

19. The method according to claim 18, comprising the step of
selecting, in dependence of said at least one location class identifier, at least one instruction; and
carrying out said at least one instruction.

20. The method according to claim 19, wherein carrying out said at least one instruction comprises at least one of the steps of
playing an audio stream and/or a visual message to a user of said hearing system;
not playing an audio stream and/or a visual message to the user of said hearing system;
carrying out an adjustment of at least one audio processing parameter of a signal processor of said hearing system.

21. The method according to claim 20, wherein said audio stream and/or a visual message and/or said adjustment is stored in said hearing system.

22. The method according to claim 20, comprising the step of
receiving said audio stream and/or a visual message and/or said adjustment in said hearing system while in said current location of said hearing system.

23. The method according to claim 14, comprising the step of
establishing a wireless communication connection between said hearing system and a communication unit external to said hearing system.

24. The method according to claim 14, wherein step a) comprises the step of
obtaining said location-related data from location-related signals, which are signals carrying information related to the hearing system's current location.
